(19) United States
(12) Patent Application Publication
(10) Pub. No.: US 2014/0146539 A1
(43) Pub. Date: May 29, 2014

(54) LED LAMP

(71) Applicants: WILLIAM CHIU, Hong Kong (HK); CHI-WEN WANG, Taoyuan County (TW)

(72) Inventor: Chin-Wen WANG, Taoyuan County (TW)

(73) Assignees: Chin-Wen WANG, Taoyuan County (TW); William CHIU, Hong Kong (HK)

(21) Appl. No.: 13/684,254

(22) Filed: Nov. 23, 2012

(51) Int. Cl. F21V 31/03

(52) U.S. Cl. CPC F21V 31/03
USPC 362/294

(57) ABSTRACT

An LED lamp includes housing, an LED chip, and a lens. The housing includes an opening shell and a cover, the opening shell has an opening, and the cover is joined with the opening shell and covers the opening. A vent penetrates the cover, and inner rim of the opening shell is bent inwardly to form a fixing part, the fixing part covers an outer fringe of the cover. The LED chip is disposed on the opening shell. The lens is disposed on the housing and corresponded to the LED chip. The lens protrudes out of the cover via the vent. The opening shell and the cover cover other component disposed with the housing, which is easily assembled and with effect of waterproof and dust-proof.

### BACKGROUND OF THE INVENTION

1. Field of the Invention

The present invention relates to an LED lamp, and in particular to an LED lamp which can be easily assembled and waterproof.

2. Description of Related Art

According to advances in manufacturing technology of light emitting diode (LED), applicative fields for using LED become broader. In the past, LED was used to be warning light, however, LED is now becoming popular in lighting applications.

Since the LED is a point light source, heat generated by the LED is concentrative. Moreover, the light shape (light distribution) of LED is not suitable for general-lighting application. Therefore, a lens for modulating light shape is necessary. Moreover, a heat-dissipating structure is also necessary to prevent the LED from burning out due to the reason of over-heat.

Furthermore, in order to take account of the special characteristics and other demands (such as waterproof property is demanded for outdoor LED lamp), LED lamp includes not merely LED and fundamental circuit for driving the LED lamp, other components is also needed, which are more than those needed by conventional lamp. These components, however, must be fixed and soldered on the LED lamp, which not only spends time for assembling the completely conventional lamp, but also increases manufacturing cost.

### SUMMARY OF THE INVENTION

It is an aspect to provide a LED lamp which can be easily assembled and with property of waterproof.

Accordingly, the LED lamp comprises a housing, an LED chip and a lens. The housing comprises an opening shell and a cover. The opening shell has an opening. The cover is joined with the opening shell and covers the opening. The cover has a vent penetrating therethrough. A rim of the opening shell is bent inwardly to form a fixing part. The fixing part covers an outer fringe of the cover. The LED chip is disposed within the housing. The lens is disposed on the housing and corresponded to the LED chip and extends out of the cover via the vent.

In a preferable embodiment, the LED lamp further comprises a vapor chamber disposed within the housing, one surface of the vapor chamber is attached to the LED chip, and the other surface of the vapor chamber is attached to an inner underside of the opening shell.

In a preferable embodiment, the LED lamp further comprises a heat-dissipating plate, the heat-dissipating plate is disposed within the housing and attached to opening shell, the heat-dissipating plate has a thermal-conductive hole penetrating therethrough. The vapor chamber is disposed within the thermal-conductive hole, and an outer fringe of the vapor chamber is contacted to an inner fringe of the thermal-conductive hole.

In a preferable embodiment, the LED lamp further comprises a waterproof cover disposed at an inside of the cover, a first vacancy and a second vacancy are disposed on two opposite surfaces of the waterproof, respectively, the first vacancy is disposed toward the opening shell, and the second vacancy is disposed toward the cover, wherein the LED chip and the vapor chamber is disposed within the first vacancy, and the lens is disposed on the second vacancy.

In a preferable embodiment, a communicating hole penetrates through the first vacancy and second vacancy, the LED chip is aligned with the communicating hole.

In a preferable embodiment, the LED lamp further comprises a partition, the partition is located within the first vacancy and attached to the lens, a light-previous hole penetrates the partition, the light-previous hole aligned with the LED chip.

In a preferable embodiment, the LED lamp further comprises a waterproof ring arranged around an outer fringe of the housing.

In a preferable embodiment, the LED lamp further comprises a threading joint disposed at outside of the opening shell and communicating the opening shell.

The LED lamp of the present invention covers components within the housing and then achieves the effect of waterproof, and the housing is assembled by the opening shell and cover which can be easily assembled.

### BRIEF DESCRIPTION OF DRAWING

The features of the invention believed to be novel are set forth with particularity in the appended claims. The invention itself however may be best understood by reference to the following detailed description of the invention, which describes certain exemplary embodiments of the invention, taken in conjunction with the accompanying drawings in which:

FIG. 1 is a schematic view of an LED lamp according to the present invention.

FIG. 2 is a perspective view of the LED lamp according to the present invention.

FIG. 3 is another perspective view of the LED lamp according to the present invention.

FIG. 4 is a partially sectional view of the LED lamp according to the present invention.

FIG. 5 is sectional view of the LED lamp according to the present invention.

FIG. 6 is another sectional view of the LED lamp according to the present invention.

FIG. 7 is a schematic view of using state of the LED lamp according to the present invention.

### DETAILED DESCRIPTION OF THE INVENTION

A preferred embodiment of the present invention will be described with reference to the drawings.

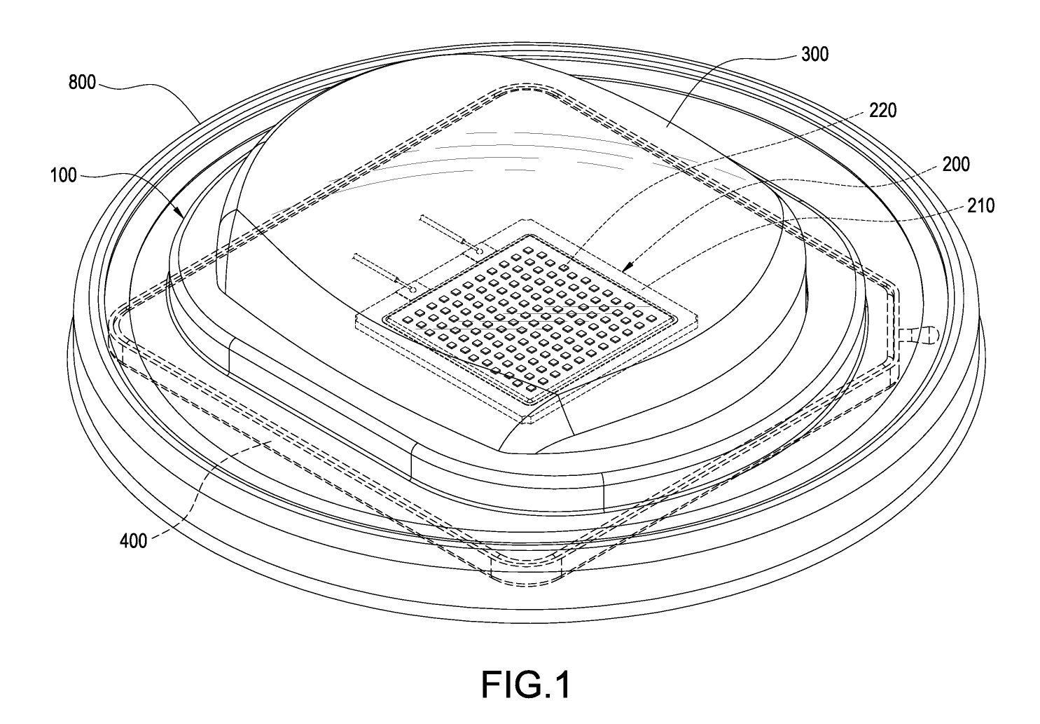

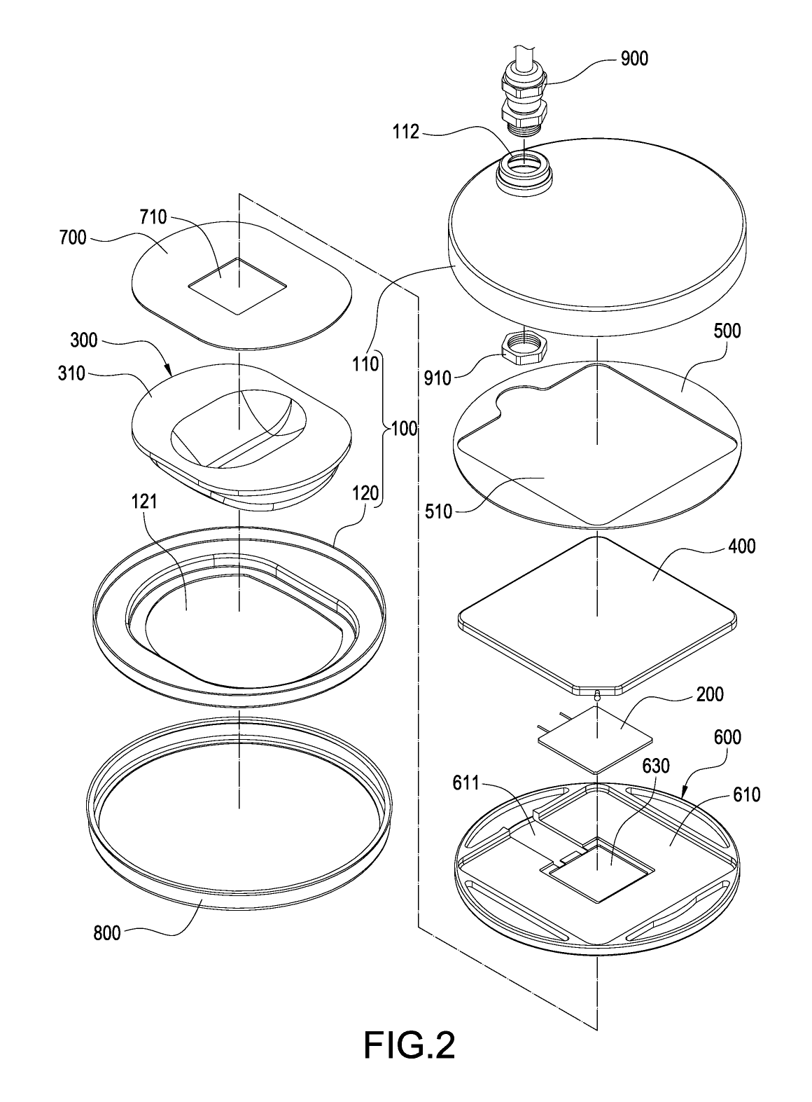

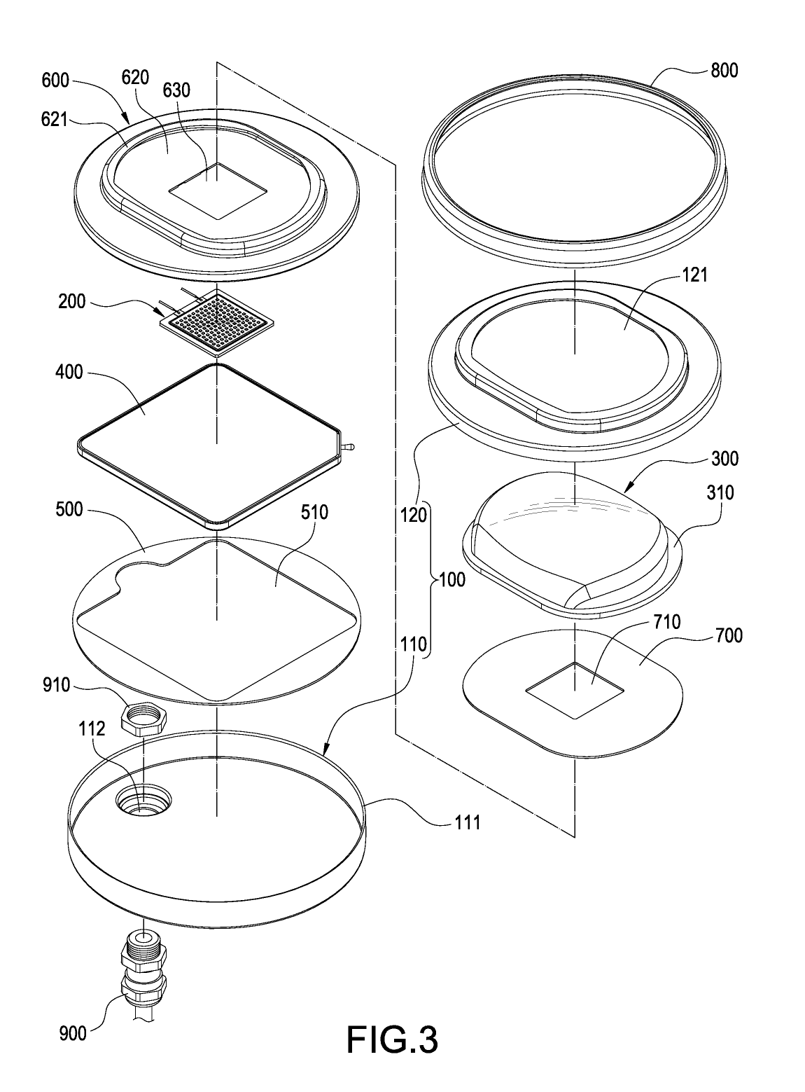

Referring to FIG. 1 to FIG. 3, FIG. 1 is a schematic view of an LED lamp according to the present invention, FIG. 2 is a perspective view of the LED lamp according to the present invention, and FIG. 3 is another perspective view of the LED lamp according to the present invention. The LED lamp includes a housing 100, an LED chip 200, a lens 300, a vapor chamber 400, a heat-dissipating plate 500, a waterproof cover 600, a partition 700, a waterproof ring 800, and a threading joint 900.

The housing 100 has an opening shell 110 and a cover 120. The opening shell 110 is preferably made of aluminum and has an opening 111, and a threading hole 112 is perforated through an underside of the opening shell 111. The cover 120 is preferably made of stainless steel and joined with the opening shell 110 and covers the opening 111 for closing the housing 100. The cover 120 has a vent 121 penetrating therethrough, and a profile of an inner fringe of the vent 121 is preferably corresponded to a profile of the lens 300.

The LED chip 200 is disposed within the housing 100. The LED chip 200 includes a substrate 210 and a plurality of LED dies 220 disposed on the substrate 210.

The lens 300 is preferably made of the transparent glass. The lens 300 is disposed within the housing 100 and aligned with the LED chip 200. The lens 300 extends out of the cover 120 via the vent 121. The lens 300 is used for refracting and guiding light generated from the LED chip 120 outwardly from the housing 100 and modulating light into a demanded light shape. A stopper 310 is protruding out of a rim of the lens 300 for abutting against an inner fringe of the vent 121 and prevents the lens 300 from coming off via the vent 121.

The vapor chamber 400 is disposed within the housing 100. One surface of the vapor chamber 400 is attached to the LED chip 200, and the other surface of the vapor chamber 400 is attached to an inner underside of the opening shell 110. The vapor chamber 400 is used for absorbing heat generated by the LED chip 200 which is lighting, for diffusing the heat the whole vapor chamber 200, and for conducting the heat out of the housing 100 via the opening shell 110. The vapor camber 400 is preferably a planiform shell filled with a working fluid and made of metal with higher thermal conductivity, such as copper or aluminum.

The heat-dissipating plate 500, which is preferably made of steel, is disposed within the housing 100 and attached to the inner underside of the opening shell 110. A thermal-conductive hole 510 penetrates the heat-dissipating plate 500. The vapor chamber 400 is disposed within the thermal-conductive hole 510, and an outer fringe of the vapor chamber 400 is in contact with an inner fringe of the thermal-conductive hole 510, such that the heat-dissipating plate 500 conducts heat, which is absorbed by the vapor chamber 400, to the opening shell 110.

The waterproof cover 600, which is substantially of plate-disk shape and preferably made of silicone, is disposed at inside of the cover 120. The profile of the waterproof cover 600 is corresponded to an inner outline of the cover 120. A first vacancy 610 and a second vacancy 620 are disposed on two opposite surfaces of the waterproof cover 600, respectively. In particularly, the first vacancy 610 is disposed toward the opening shell 110, and the second vacancy 620 is disposed toward the cover 120. The LED chip 200 and the vapor chamber 400 are disposed within the first vacancy 610, and the lens 300 is disposed on the second vacancy 620. An communicating hole 630 penetrates the first vacancy 610 and the second vacancy 620, and an inner outline of the communicating hole 630 is preferably corresponded to the profile of the LED chip 200. The LED chip 200 is aligned with the communicating hole 630, such that light generated by the LED chip 200 can be injected to the lens 300 via the communicating hole 630. A waterproof flange 621 is protruding inwardly from a fringe of the first vacancy 610. The flange 621 is located between the stopper 310 and an inner rim of the vent 121 to prevent foreign objects (such as water, dust) from intruding into the housing 100. A threading groove 621 is disposed on an inside of the first vacancy 610. The threading groove 621 is extending form the edge of the communicating hole 630 and aligned with the threading hole 112.

The partition 700, which is preferably made of stainless steel, is located within the first vacancy 610 and attached to the lens 300. A light-pervious hole 710 penetrates through the partition 700 and is aligned with the LED chip 200 for passing light generated by the LED chip 200.

The threading joint 900 is disposed at outside of the opening shell 110 and communicates the opening shell 110 via the threading hole 112. A nut 910 fastens the threading joint 900 and the threading hole 112 together for accommodating electric wires. The threading joint 900 may have electric wires disposed therein. One end of each electric wire passes through the threading hole 112 and the threading groove 611 and then is electrically connected to the LED chip 200, and the other end of each wire is electrically connected to an electric power for driving the LED chip 200 and lighting the LED chip 200.

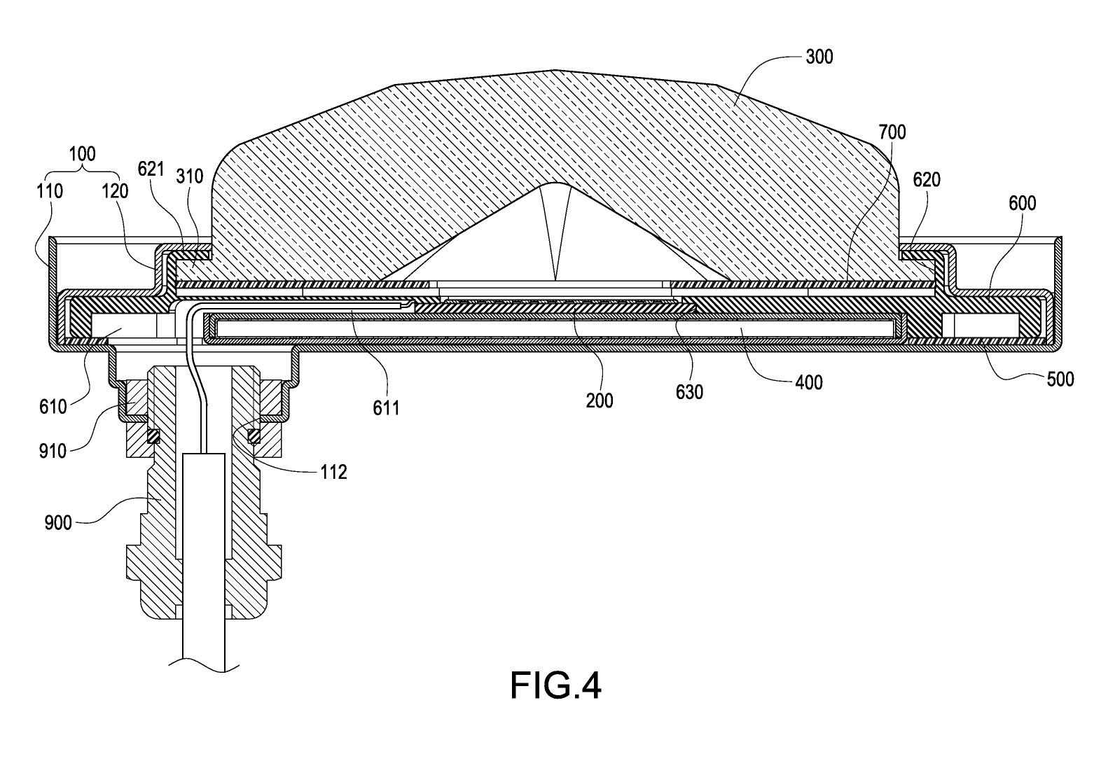

Referring to FIG. 4, FIG. 4 is a partially sectional view of the LED lamp according to the present invention. The opening shell 110 is joined with the cover 120, and then an inner rim of the opening shell 110 is bent inwardly to form a fixing part 113. The fixing part 110 covers an outer fringe of the cover 120 and fixes the opening shell 110 and cover 120.

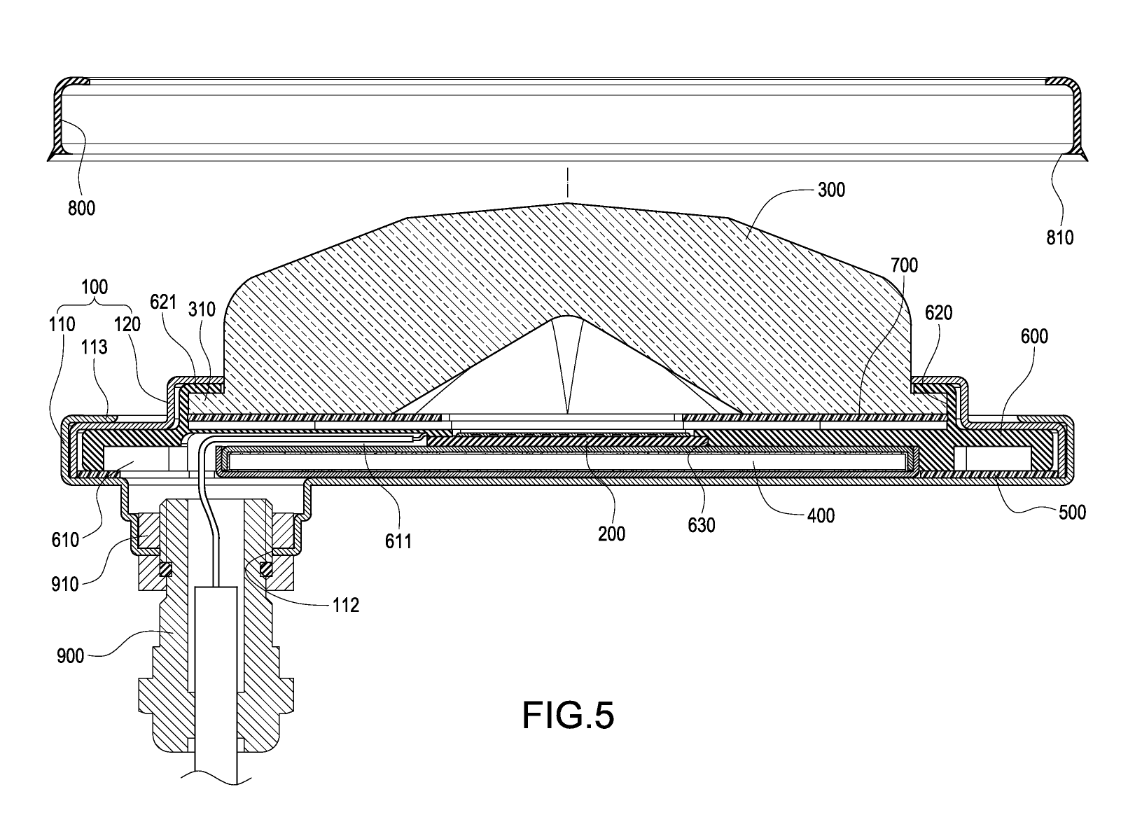

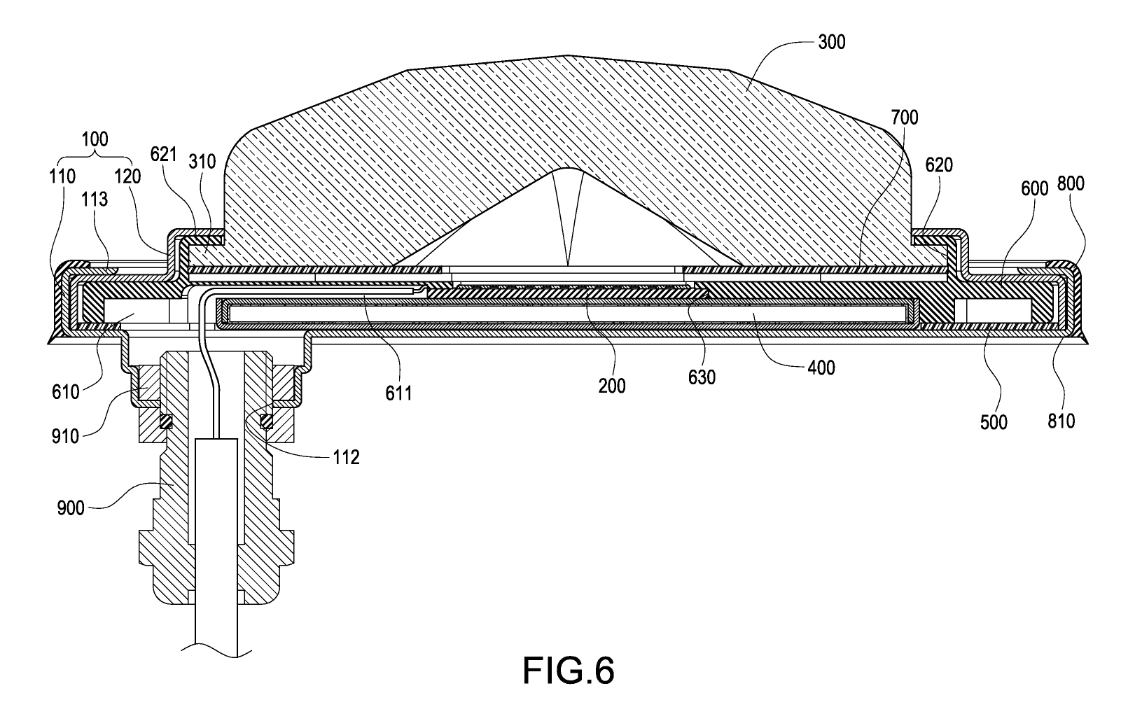

Referring to FIG. 5 and FIG. 6, FIG. 5 and FIG. 6 are sectional views of the LED lamp according to the present invention. The waterproof ring 800 is preferably made of silicone and is joined with an outer fringe of the housing 100. A sealing part 810 protrudes out of an outer fringe of the waterproof ring 800 which is approaching where the opening shell 110 is disposed. The sealing part 810 extends around the waterproof ring 800.

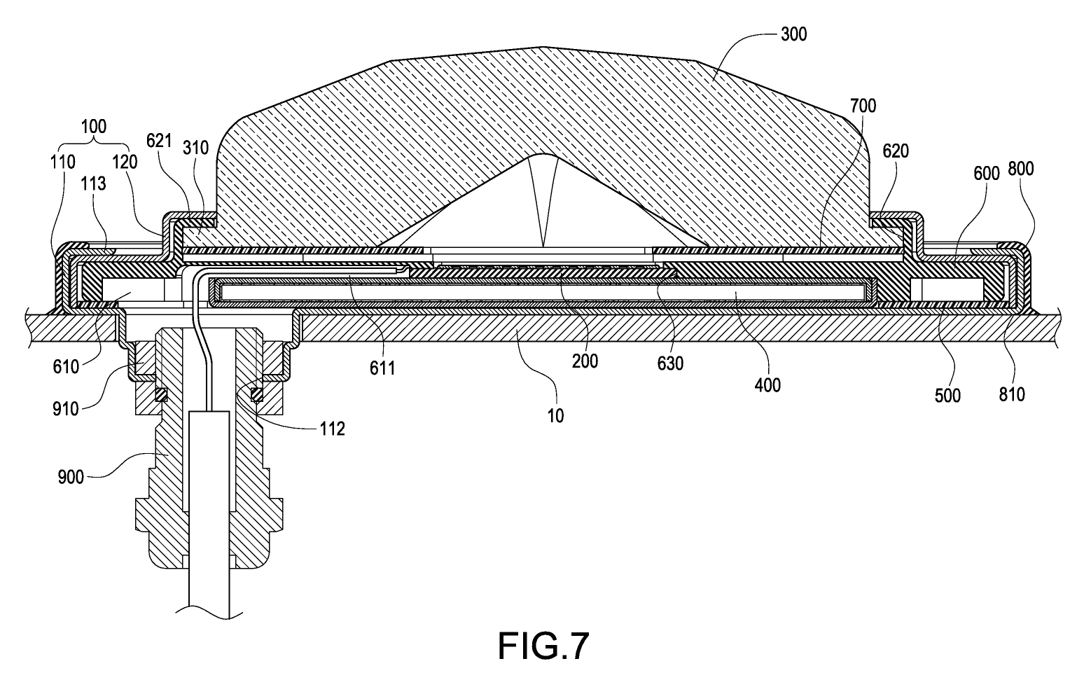

Referring to FIG. 7, the LED lamp is disposed on a plate 10, an underside of the opening shell 110 is attached to the plate 10, and the threading joint 900 penetrates into the plate 10. The plate 10 is a disposing area such as ceiling or wall, the sealing part 810 is connected to the plate 10 to prevent foreign objects (such as water, dust) from intruding into chinks located between the housing 100 and the plate 10.

The LED lamp of the present invention covers components within the housing 100, and then achieves the effect of waterproof. Besides, the housing 100 is assembled by the opening shell 110 and the cover 120, the component disposed therein are fixed by stacking, which do not need screws and can be easily assembled.

Although the present invention has been described with reference to the foregoing preferred embodiment, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. An LED lamp comprising:
a hosing comprising an opening shell and a cover, the opening shell having an opening, the cover joined with the opening shell and covering the opening, the cover having a vent perforated therethrough, a rim of the opening bent inwardly to from a fixing part for covering an outer fringe of the cover;
an LED chip disposed within the housing; and
a lens disposed within the housing, aligned with the LED chip, and extending out of the cover via the vent.

2. The LED lamp in claim 1, further comprising a vapor chamber, the vapor chamber is disposed within the housing, one surface of the vapor chamber is attached to the LED chip, and the other surface of the vapor chamber is attached to an inner underside of the opening shell.

3. The LED lamp in claim 2, further comprising a heat-dissipating plate disposed within the housing and attached to the opening shell, the heat-dissipating plate has a thermal-conductive hole penetrating therethrough, the vapor chamber is disposed within the thermal-conductive hole, and an outer fringe of the vapor chamber is contacted to an inner fringe of the thermal-conductive hole.

4. The LED lamp in claim 2, further comprising a waterproof cover disposed at an inside of the cover, a first vacancy and a second vacancy being disposed on two opposite surfaces of the waterproof cover, wherein the first vacancy is disposed toward the opening shell, and the second vacancy is disposed toward the cover, the LED chip and the vapor chamber are disposed within the first vacancy, and the lens is disposed on the second vacancy.

5. The LED lamp in claim 4, wherein a communicating hole penetrates through the first vacancy and the second vacancy, the LED chip is aligned with the communicating hole.

6. The LED lamp in claim 4, further comprising a partition located within the first vacancy and attached to the lens, a light-previous hole penetrating the partition, the light-previous hole is aligned with the LED chip.

7. The LED lamp in claim 1, further comprising a waterproof ring arranged around an outer fringe of the housing.

8. The LED lamp in claim 1, further comprising a threading joint disposed at outside of the opening shell and communicating the opening shell.
